(19) United States
(12) Patent Application Publication
(10) Pub. No.: US 2005/0233667 A1
(43) Pub. Date: Oct. 20, 2005

(54) System and method for manufacturing polymer mat with reduced capacity spinning pumps

(75) Inventor: Aaron Hobart, Joplin, MO (US)

Correspondence Address: Jeffrey B. Williams;SHOOK, HARDY & BACON L.L.P., One Kansas City Place, 1200 Main Street, Kansas City, MO, 64105-2118, US

(73) Assignee: Tamko Roofing Products, Inc.

(21) Appl. No.: 10/826,562

(22) Filed: Apr. 16, 2004

(51) Int. Cl. D04H 5/02; D04H 5/00; D04H 3/10; D04H 1/46; A01J 25/12; B28B 21/52; A01J 21/02; A21C 11/16; A21C 3/04; D04H 13/00; D04H 3/00; D04H 1/00; D01D 1/10; B29C 43/22; B29C 41/24; B29C 39/14; B28B 11/18; B29D 7/00; B29C 63/00; B29C 51/02; B29C 47/06; B29C 47/04; B29C 47/02; B29C 47/00; B29C 31/10; B28B 13/00; A21C 11/00; A23G 3/18; A23G 3/16; A23G 3/12; A21C 3/00; A23G 1/22; A23G 1/20; A23P 1/00; B28B 5/00

(52) U.S. Cl. 442/402; 425/72.2; 425/131.5; 425/382.2; 264/166

(57) ABSTRACT

A system and method for manufacturing polymer mat utilizes reduced capacity spinning pumps. The system includes at least one extruder, at least one pump receiving an extruded polymer, and a plurality of spinning packs each having a plate with multiple orifices. One or more of the spinning packs has a lesser number of orifices than the remaining spinning packs. Therefore, when extruding fibers to form polymer mats, a less dense amount of fibers are disposed along selected locations (e.g., laterally marginal areas if the mat). By this system and associated method, the amount of trim generated in the production of polymer fibers may be reduced. This results in increased efficiency in the fabrication of spunbond or woven mats.

### CROSS-REFERENCE TO RELATED APPLICATIONS

None.

### STATEMENT REGARDING FEDERALLY SPONSORED RESEARCH OR DEVELOPMENT

Not Applicable.

### BACKGROUND OF THE INVENTION

This invention relates generally to the production of mat structures. Particularly, the invention relates to the production of polymer fibers created through melt spinning and the methods and systems by which such fibers are turned into spunbond or non-woven needle punched fibrous mats.

Melt spinning generally involves extrusion of thermoplastics to create molten polymers. The molten polymers are extruded through a system that includes at least an extruder and generally one or more spinning pumps to force molten polymer through spinning packs. Each spinning pack contains a spinnerette, and generally includes a block and breaker or filter as well.

Fibers or filaments are created when the molten polymer passes through the elements of the spinning pack, eventually passing through a series of small orifices in the spinnerette. This produces fine, small diameter strands of polymers that are pulled from the spinning pack or dropped freely from the spinnerette. These strands are generally quenched or cooled, and then fed into a system for creating the mat. The fibers are collected, either through a pull-through system or by receipt on a conveyor belt, and are then compressed or needle punched to make the mat.

Typically the number of orifices in a spinnerette should be as high as possible to maximize the filament production rate. In other words, in commonly used systems the number of orifices is selected to create a sufficient number of filaments per time increment to fully utilize the conveyor belt of the collection process and create a consistent distribution of filaments per unit area of the belt.

These systems, however, create a considerable amount of trim, or excess fibers that either overhang or drop outside the width of the belt, or otherwise need to be cut-off to make the mat the proper size. This trim is often not recyclable, because once the polymers have been extruded they cannot be put back into the system.

### SUMMARY OF THE INVENTION

The present invention provides an improved system and method for reducing the amount of trim generated in the production of polymer fibers, thereby making the process of creating spunbond or woven mats more efficient.

In one aspect, an improved system for manufacturing a polymer mat includes at least one extruder, at least one pump receiving an extruded polymer, and a plurality of spinning packs each having a plate with multiple orifices, wherein at least one spinning pack of the plurality of spinning packs has a lesser number of orifices than the remaining spinning packs. By reducing the capacity of selected spinning packs on the outside edges through reduced orifice density at marginal locations, trim, as well as overall waste, is reduced.

In another aspect, a process is disclosed for producing filaments for a mat. The process includes extruding a polymer and passing the extruded polymer through a plurality of spinning packs located above a conveyor belt, each spinning pack having a plurality of orifices with portion of the spinning packs located above an outer edge of the conveyor belt have a lower orifice density than the orifice density of the spinning packs located above a central portion of the conveyor belt. As a result, the average number of filaments per unit area of the conveyor belt received at an outer lateral edge of the conveyor belt is less than the number of filaments per unit area of the conveyor belt received at a central portion of the conveyor belt.

The invention of another aspect provides for a reduced capacity spinning pack for use in production of polymer filaments. The spinning pack includes a block containing a series of flow channels and a spinnerette aligned with the block that receives a liquid polymer from the flow channels in the block. The spinnerette has a plurality of bores arranged on approximately one half or less of the spinneret to produce polymer filaments though only one half or less of the spinnerette.

There is also disclosed, in yet another aspect, a system for producing a polymer fiber mat fabric. The system includes (a) at least one extruder having a receiving chamber for accepting a plurality of polymer chips, and an exit die; (c) at least one pump having an outlet and an inlet that receives an extruded molten polymer after it has passed the exit die of the extruder; (d) a plurality of spinning packs each having a body and a die; wherein the body receives the extruded molten polymer and the extruded molten polymer is forced through the die by pressure from the at least one pump to form polymer filaments; (e) a conveyor belt on which the polymer filaments collect; and (f) an entangler bonding the polymer filaments into a mat.

Although in the past reducing the capacity of some spinning packs had been considered a detriment to quality of the mat, the improved systems, apparatus, and methods of manufacturing disclosed herein maintain the quality of the mat product while reducing the amount of raw material used.

### BRIEF DESCRIPTION OF THE DRAWINGS

FIG. 1 is a schematic view of an exemplary system for manufacturing polyester mat consistent with the current invention.

FIG. 2 is a bottom plan view of the spinning packs of the exemplary system shown in FIG. 1.

FIG. 3 is an exploded view of an exemplary spinning pack for use in the current invention, the spinning pack including a block, breaker, and spinnerette.

FIG. 4 is a bottom plan view of the block shown in FIG. 3.

FIG. 5 is an exploded view of another exemplary spinning pack for use in the current invention, the spinning pack including a block, breaker, and spinnerette.

FIG. 6 is a bottom plan view of the block shown in FIG. 5.

FIG. 7 is a fragmentary close-up view of the orifices in a spinnerette.

FIG. 8 is a cross-sectional view taken along line 8-8 showing the profile of the orifices of the breaker and spinneret.

### DESCRIPTION OF ILLUSTRATIVE EMBODIMENTS

In one preferred embodiment, a polymer mat or other spun fiber product is made with polyethylene; however, those of skill in the art will appreciate that polypropylene, nylon, or other polymers and thermoplastics, or equivalent materials, may also be used with the systems and methods of the present invention. Moreover, a variety of polymer solutions may be used consistent with the current invention.

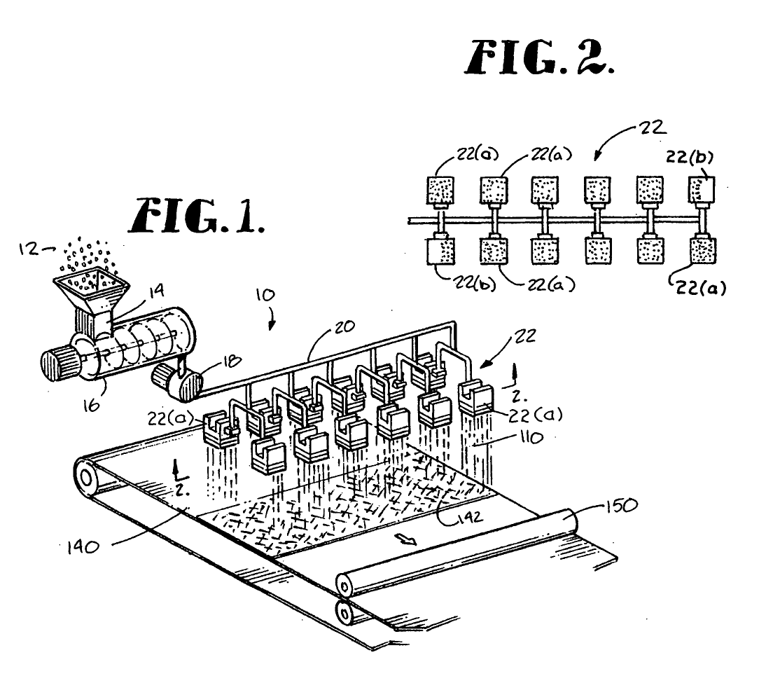

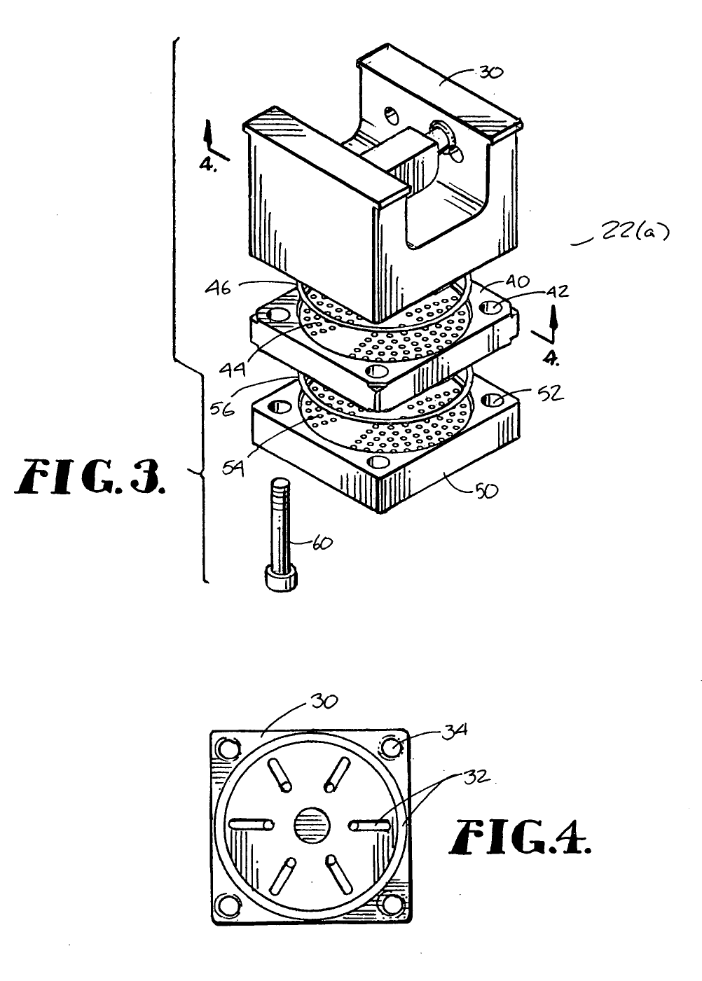

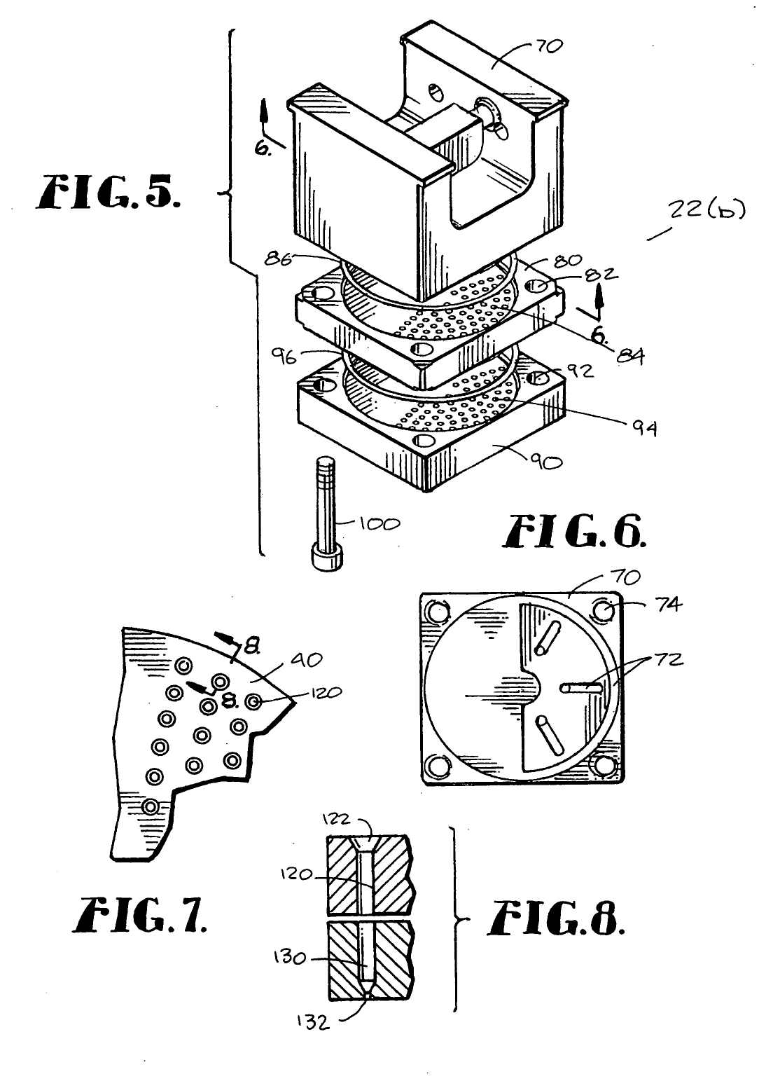

Referring to FIG. 1, one embodiment of a system 10 for manufacturing a mat is shown. Polymer chips 12 (e.g., polyethylene chips) or other thermoplastic raw material is fed into a hopper 14 or other common feed system. The polymer chips 12 are then delivered to an extruder 16. The extruder 16 may be of a type conventionally known, and for example may be a single-screw or twin-screw extruder operating with the screw(s) operating within a barrel. Inside the extruder 16, the screw grinds the chips 12, creating friction and heat that melts the chips and simultaneously forces the same forward through the extruder barrel. Thus, inside the extruder 16, heat and pressure generated by the extruder screw(s) melt the polymer chips 12 creating a molten polymer used to create fibers.

In some embodiments, the extruder 16 may dispense the molten polymer directly into a series of spinning packs to create the fibers that form the mat. However, in the embodiment shown in FIG. 1, a pump 18, or spinning pump (which may also be referred to as a melt pump, metering pump, or filament pump), receives the extruded molten polymer. In other embodiments of the system, a manifold may be incorporated to feed a plurality of spinning pumps.

The spinning pump 18 (or pumps) feeds a piping manifold 20, which supplies the molten polymer to a plurality of spinning packs 22. The use of the spinning pump 18 generates a steady feed rate for the molten polymer, which may be beneficial in that the rate is more constant than if the extruder 16 fed the spinning packs 22 directly (considering, for example, fluctuations in the output rate of the extruder 16). A steady feed rate aids in generating fibers of fairly consistent thickness and denier. However, the system of the current invention can be used in embodiments where the extrusion pressure developed by the extruder 16 is used to force the extruded polymer into the spinning packs 22 without any auxiliary pumps.

Spinning pack 22, best seen in FIGS. 3 and 5, is made of metal (e.g., aluminum or steel alloys), although other materials may be chosen as those of skill in the art will appreciate, so long as the necessary strength and thermal tolerances are met by the materials of choice. Referring to FIG. 3, one exemplary embodiment of a spinning pack 22(a) includes a body or block 30 that receives the heated polymer, a breaker 40 having multiple orifices 44, and a die or spinnerette 50 also having multiple orifices 54 preferably aligned with the orifices of the breaker. The spinning pack 22 is assembled into individual units, commonly through the use of aligned axial bores such as the bores 42 and 52 through the breaker 40 and spinnerette 50. The breaker 40 and spinnerette 50 are secured to the block 30; in the embodiment shown, a bolt 60, or other common fastener, threads through bores 52 and 42 and into a receptacle 34 (e.g., a threaded bore) in the block 30 (as shown in FIG. 4) to secure the breaker 40 and spinneret 50 to the block 30.

Referring to FIGS. 3 and 4, the molten polymer is fed by the spinning pump(s) through the assembled spinning pack 22 by way of flow channels 32 in the block 30. Pressure created by the pump forces the molten polymer to be dispersed across the orifices 44 of breaker 40. A gasket 46 or other seal is employed to contain flow of the polymer in the spinning pack 22 and more particularly through the orifices 44. Similarly, a gasket 56 contains the flow of the polymer in the spinning pack 22 to direct it though the spinnerette orifices 54.

Accordingly, referring again to FIG. 1, the feed thermoplastic material (e.g., polymer chips 12) enters the spinning pack as a stream of molten polymer and exits through the spinnerette orifices 54 as a plurality of extruded fibers or filaments 110, hardenable strands of the polymer material. In one embodiment, the spinning packs 22 may also contain upstream filter elements (not shown) to aid in removing unmelted polymer or other solids that could block the orifices 44 and degrade production and the continuity of the filaments.

Another exemplary embodiment of spinning packs 22 for use in the current invention is reduced capacity spinning pack 22(b) as shown in FIG. 2 and in more detail in FIG. 5. Spinning pack 22(b) includes a block 70 that receives the heated polymer, a breaker 80 having multiple orifices 84, and a die or spinnerette 90 also having multiple orifices 94 preferably aligned with the orifices of the breaker. However, as can be seen in FIG. 2, and in comparing FIGS. 3 and 5, spinning pack 22(b) contains a lower orifice density than spinning pack 22(a). In the embodiments shown, there is a relatively smaller number of orifices or bores through breaker 80 and spinnerette 90 of spinning pack 22(b) than through breaker 40 and spinnerette 50 of spinning pack 22(a). As one example, the orifices 84 and 94, of the breaker 80 and spinneret 90, respectively, may extend in radial rows on the breaker and spinneret for less than 180 degrees around the breaker and spinneret, and may have about 50% or less orifices in comparison to that of the breaker 40 and spinneret 50 of the non-reduced capacity spinning pack 22(a).

As shown in FIGS. 7 and 8, the orifices 44 through breaker 40 (and orifices 84 through breaker 80 of the reduced capacity spinning pack 22(b)) may have a greater diameter portion 120 than the spinnerette orifices 54, 94 reduced diameter portion 130, thereby step reducing the thickness of the filament as it passes through the spinning packs 22(a) and 22(b), creating a fine filament and a preferred denier at the spinning pack exit orifice 132. In a preferred embodiment the orifices 44, 54, 84, 94 in the spinning pack have a circular cross-section. The diameter of the orifices through a breaker 40 or 80 (and through a spinneret 50 or 90) is preferably in the range of 0.4 to 3 millimeters. In addition, the diameter of the orifices through the breaker 40 or 80 may vary over the length of the bore as shown in FIG. 8. In particular embodiments there may be a counter bore 122 having a first relatively greater diameter at the upstream end of the breaker orifice 120 and a relatively smaller orifice at the downstream end of the orifice. As one example, the diameter of the counter bore 122 at the upstream end may be about 50% larger or greater than the diameter of the downstream end. Additionally, the bore 130 through the die or spinnerette 50 or 90 may have a relatively smaller spinning orifice 132 at the downstream exit from the spinneret.

The spinning packs may be arranged in rows as shown in FIG. 2. Various combinations of rows and numbers of spinning packs 22 are consistent with the spirit and scope of the present invention. For example, although a two-row embodiment is shown in FIGS. 1 and 2, embodiments are envisioned wherein there are one, three, four or six or more rows of spinning packs. Each row may be fed the molten polymer by one or more extruders and may also employ one or more dedicated spinning pumps or a series of spinning pumps associated with the row or with each spinning pack. In one preferred arrangement, the set of spinning packs 22 includes reduced capacity spinning packs 22(b) located

Each row is generally located near the adjacent row, so that the output filaments 110 are enmeshed as the filaments drop in various directions to the conveyor belt 140 below. The polymer filaments 110 are solidified after exiting the spinning packs by the ambient air outside the spinning packs 22 which has a temperature cooler than the output filaments. As shown in FIG. 1, the filaments 110 are dropped from the spinning packs 22 located above a conveyor belt 140 onto the belt creating a randomly directed array 142 of thin polymeric fibers. The conveyor belt 140 may contain a series of holes (not shown) through which air is drawn down through the belt to hold the filaments 142 in place during the further process of creating the mat.

It is important to obtain a steady distribution of fibers 110 across conveyor belt 140 in order to produce a mat with relatively consistent thickness and weight. One way of achieving this is to implement the exemplary spinning pack arrangement shown in FIG. 2. In this arrangement, the set of spinning packs 22 includes reduced capacity spinning packs 22(b) located on opposite ends of the spinning pack set near lateral edges of the conveyor belt 140 and on adjacent rows such that the reduced capacity spinning packs 22(b) are diametrically opposed from one another.

As shown in FIGS. 1 and 2, in one embodiment of the current invention the orifice density of the spinnerettes in spinning packs 22 is reduced at the portion of the spinning pack(s) located above the outer lateral edges of the conveyor belt. Thus for the embodiment shown in FIG. 1, the outer spinning packs 22 in the rows, designated 22(b) and located nearest and above the outer edges of the conveyor belt, have a reduced number of orifices, as can be seen in FIG. 2. By use of the reduced capacity spinning packs 22(b), excess material and trim waste may be reduced.

In embodiments of the invention where there are a plurality of spinning pumps, the output capacity of certain spinning pumps may be reduced, particularly those spinning pumps most associated with the reduced capacity spinning packs 22(b). This pump capacity reduction may be accomplished by reducing the pump motor rpm, by running at the same rpm with a restricting orifice plate, or by other common means. The reduced capacity pumps would be located in the system to correspond with the lower orifice density spinning packs.

### EXAMPLE

Two rows of thirty spinning packs and associated spinning pumps were used in a production trial. In each row, the two outermost spinning packs were replaced with reduced capacity spinning packs, particularly spinning packs wherein the number of orifices in the die was reduced by about fifty percent. The orifice pattern of the spinning packs was similar to that shown in the spinning packs 22(b) of FIG. 5. The bores 84 in the breaker plate 80 had a diameter of 3.0 millimeters with a 60° chamfer. Each bore 84 was substantially aligned with the bores in the spinnerette, and each bore in the spinnerette was 3.0 in diameter at the inlet reducing to 0.4 millimeters at the spinning nozzle.

In the exemplary test, each spinning pump associated with a reduced capacity spinning pack was run at consistent rpm but with half of the throughput. The polymer raw material used in the test example was polyethylene terephthalate.

As a result of this production trial, trim was reduced by about thirty percent. This resulted in significant savings in the cost of raw material, with no reduction in the product quality. In the past, it was a widely held belief that reducing the capacity of the spinning packs would result in a product that did not meet quality standards, particularly in the areas of the reduction where product weight or uniformity of thickness were expected to suffer. However, this was not the case.

It is envisioned that in other embodiments, there may be more than one reduced capacity spinning pack 22 associated with the lateral edge portion of a row. For example, a laterally outermost pack 22 may have a certain reduction in capacity such as fifty percent, the adjacent spinning pack 22 in the row may have a lesser reduction in capacity such as twenty-five percent, and the laterally innermost spinning packs 22 have no reduction in capacity. Moreover, the individual spinning packs 22 may be replaced by one or more spinning packs having relatively longer openings, for example rectangular slots, where the opening(s) are sized to cover the width of the conveyor belt 140 that receives the extruded filaments 110. The extrusion orifices would be spaced across the opening. In such an embodiment, the number of orifices closest to the edge portions of the opening, i.e., those closest to the lateral edges of the conveyor belt 140, would be reduced to decrease filament production in the outer edge margins of the mat, thereby reducing trim and waste.

Referring again to FIG. 1, the array of filaments 142 passes along the conveyor belt 140 and is bonded in an entangler 150 to create the mat. The entangler 150 is shown in the form of one or more compression rollers. However, the entangler 150 may also comprise a needling section of the system 10. In the needling section, thousands of needles may be installed on a camshaft to needle punch the filaments into a mat forming a stable fabric. The mat may be needled on one side, then pass through a second needling section that needle punches the other side.

Since certain changes may be made in the above systems and methods without departing from the scope hereof, it is intended that all matter contained in the above description or shown in the accompanying drawing be interpreted as illustrative and not in a limiting sense. It is also to be understood that the following claims are to cover certain generic and specific features described herein.

1. A system for manufacturing a polymer mat comprising:
at least one extruder;
at least one pump receiving an extruded polymer from the at least one extruder;
a plurality of spinning packs receiving the extruded polymer from the at least one pump, each spinning pack having a plate with multiple orifices, wherein at least one spinning pack of the plurality of spinning packs has a lesser number of orifices than one or more of the remaining spinning packs;
a belt, the belt located below the plurality of spinning packs and positioned to receive a plurality of polymer filaments created when the extruded polymer is passed through the plurality of spinning packs; and
an entangling means receiving the plurality of polymer filaments from the belt, the entangling means forming the plurality of polymer fibers into a mat.

2. The system of claim 1, wherein the at least one spinning pack of the plurality of spinning packs having a lesser number of orifices is aligned with an outer lateral edge of the belt.

3. The system of claim 1, wherein the at least one spinning pack of the plurality of spinning packs having a lesser number of orifices comprises a series of spinning packs having a lesser number of orifices positioned as the laterally outermost spinning packs in a row of spinning packs.

4. The system of claim 1, wherein the at least one spinning pack of the plurality of spinning packs having a lesser number of orifices has about fifty percent or less as many orifices as the remaining spinning packs.

5. A system for producing polymer fibers comprising:
at least one extruder;
at least one pump receiving an extruded polymer;
a plurality of spinning packs receiving a feed polymer from the at least one pump, wherein each spinning pack contains a die with multiple orifices and at least one first spinning pack of the plurality of spinning packs contains a die with a reduced number of orifices as compared to at least one remaining second spinning pack of the plurality of spinning packs.

6. The system of claim 5, wherein the polymer fibers are polyethylene fibers.

7. The system of claim 5, wherein each of the orifices of the at least one spinning pack comprises a bore having a first end to receive the feed polyethylene and a second end that outputs a filament, the first end having a diameter at least about 50% or more larger than a diameter of the second end.

8. A process for producing filaments for a mat comprising:
extruding a polymer;
passing the extruded polymer through a plurality of spinning packs each having a plurality of orifices, the plurality of spinning packs located above a conveyor belt and wherein a portion of the spinning packs located above a lateral outer edge of the conveyor belt have a lower orifice density than the orifice density of the spinning packs located above a central portion of the conveyor belt, whereby a plurality of filaments are created;
receiving, by the conveyor belt, the plurality of filaments, wherein the number of filaments per unit area of the conveyor belt received at the outer lateral edge of the conveyor belt is less than the number of filaments per unit area of the conveyor belt received at a central portion of the conveyor belt.

9. The process of claim 8, wherein the extruded polymer is pumped through the spinning packs.

10. The process of claim 9, wherein a plurality of spinning pumps are associated with the plurality of spinning packs.

11. The process of claim 10, wherein the output of the portion of the spinning packs located above the lateral outer edge of the conveyor belt is less than the output of the spinning packs located above the central portion of the conveyor belt.

12. A system for producing a polymer fiber mat fabric, the system comprising:
at least one extruder, the extruder having a receiving chamber for receiving a plurality of polymer chips and an exit die;
at least one pump having an inlet and an outlet, the inlet receiving an extruded molten polymer after it has passed the exit die of the extruder;
a plurality of spinning packs, each of said spinning packs having a body and a die, wherein the body receives the extruded molten polymer and the extruded molten polymer is forced through the die by pressure from the at least one pump to form polymer filaments;
a conveyor belt on which the polymer filaments collect; and
an entangler bonding the polymer filaments into a mat.

13. A reduced capacity spinning pack for use in production of polymer filaments, the spinning pack comprising:
a block containing a series of flow channels;
a spinnerette aligned with the block, the spinnerette receiving a molten polymer from the flow channels in the block; and
a plurality of bores extending through the spinnerette, the bores arranged on less than about one half of the spinnerette to produce the polymer filaments from the molten polymer only though said less than about one half of the spinneret where the bores are located.

14. The spinning pack of claim 13, wherein each of the plurality of bores has a first end to receive the molten polymer and a second end that outputs the polymer filament, the first end having a diameter at least about 50% or more larger than a diameter of the second end.

15. A polymer mat which comprises:
an array of non-woven thermoplastic fibers, wherein the fibers are entangled by;
a) extruding polymer filaments through a plurality of spinning packs containing orifices for deposition of the filaments on a conveyor belt, wherein at least two of the plurality of spinning packs located above outer lateral edges of the conveyor belt have fewer orifices than the spinning packs located above the center of the conveyor belt; and
b) needling the polymer filaments on the conveyor belt to create a mat.

16. A polymer mat which comprises:
an array of non-woven thermoplastic fibers, wherein the fibers are entangled by;
a) extruding polymer filaments through a plurality of spinning packs containing orifices for deposition on a conveyor belt, wherein at least two of the plurality of spinning packs located above outer edges of the conveyor belt have fewer orifices than the spinning packs located above the center of the conveyor belt; and
b) compressing the polymer filaments on the conveyor belt to create a mat.
